(19) United States
(12) Patent Application Publication
(10) Pub. No.: US 2008/0069316 A1
(43) Pub. Date: Mar. 20, 2008

(54) METHOD AND APPARATUS FOR PROCESSING VOICEMAIL MESSAGES IN A MULTI-USER SETTING

(75) Inventors: EDWARD WALTER, BOERNE, TX (US); LARRY B. PEARSON, SAN ANTONIO, TX (US)

Correspondence Address: AKERMAN SENTERFITT, P.O. BOX 3188, WEST PALM BEACH, FL, 33402-3188, US

(73) Assignee: SBC KNOWLEDGE VENTURES, L.P., RENO, NV (US)

(21) Appl. No.: 11/533,720

(22) Filed: Sep. 20, 2006

(51) Int. Cl. H04M 11/00

(52) U.S. Cl. 379/88.18

(57) ABSTRACT

A method and apparatus for processing voicemail messages in a multi-user setting is disclosed. An apparatus that incorporates teachings of the present disclosure may include, for example, a Call Processing System (CPS) having a processing element that receives a redirected call initiated by a calling party attempting to communicate with at least one among a plurality of users sharing one or more terminal devices associated with a targeted communication identifier, presents the calling party an option to select one or more among the plurality of users, and directs the calling party to a voicemail system for storing a voicemail message in one or more voicemail accounts associated with the one or more users selected. Additional embodiments are disclosed.

### FIELD OF THE DISCLOSURE

The present disclosure relates generally to voicemail techniques and more specifically to a method and apparatus for processing voicemail messages in a multi-user setting.

### BACKGROUND

Fixed communication devices such as PSTN (Public Switched Telephone Network) or VoIP (Voice over IP) phones used in a residence or commercial enterprise as well as portable cell phones have become a necessity for many people to manage in part their daily activities. In a multi-user setting in which said devices are shared by multiple parties, it is not clear to whom a calling party may have directed a voicemail message without one of said users listening to the voicemail message first.

A need therefore arises for a method and apparatus for processing voicemail messages in a multi-user setting.

### BRIEF DESCRIPTION OF THE DRAWINGS

FIG. 1 depicts an exemplary embodiment of a communication system for processing voicemail messages;

FIG. 2 depicts an exemplary method operating in the communication system;

FIG. 3 depicts a multi-user setting for sharing one or more terminal devices;

FIGS. 4-5 depict exemplary embodiments of the terminal device; and

FIG. 6 depicts an exemplary diagrammatic representation of a machine in the form of a computer system within which a set of instructions, when executed, may cause the machine to perform any one or more of the methodologies disclosed herein.

### DETAILED DESCRIPTION

Embodiments in accordance with the present disclosure provide a method and apparatus for processing voicemail messages in a multi-user setting.

In a first embodiment of the present disclosure, a Call Processing System (CPS) can have a controller element that receives a redirected call initiated by a calling party attempting to communicate with at least one among a plurality of users sharing one or more terminal devices associated with a targeted communication identifier, presents the calling party an option to select one or more users among the plurality of users, and directs the calling party to a voicemail system for storing a voicemail message in one or more voicemail accounts associated with the one or more users selected.

In a second embodiment of the present disclosure, a voicemail system can have a controller element that stores a voicemail message of a calling party in one or more voicemail accounts associated with one or more users sharing a targeted communication identifier, wherein the one or more voicemail accounts are selected by the calling party by way of an Interactive Voice Response (IVR) system.

In a third embodiment of the present disclosure, a computer-readable storage medium in a terminal device can have computer instructions for receiving a notice identifying a user among a plurality of users sharing a targeted communication identifier from which the terminal device operates, the notice identifying a pending voicemail message originating from a calling party that directs by way of an Interactive Voice Response (IVR) system the voicemail message to the user identified by the notice.

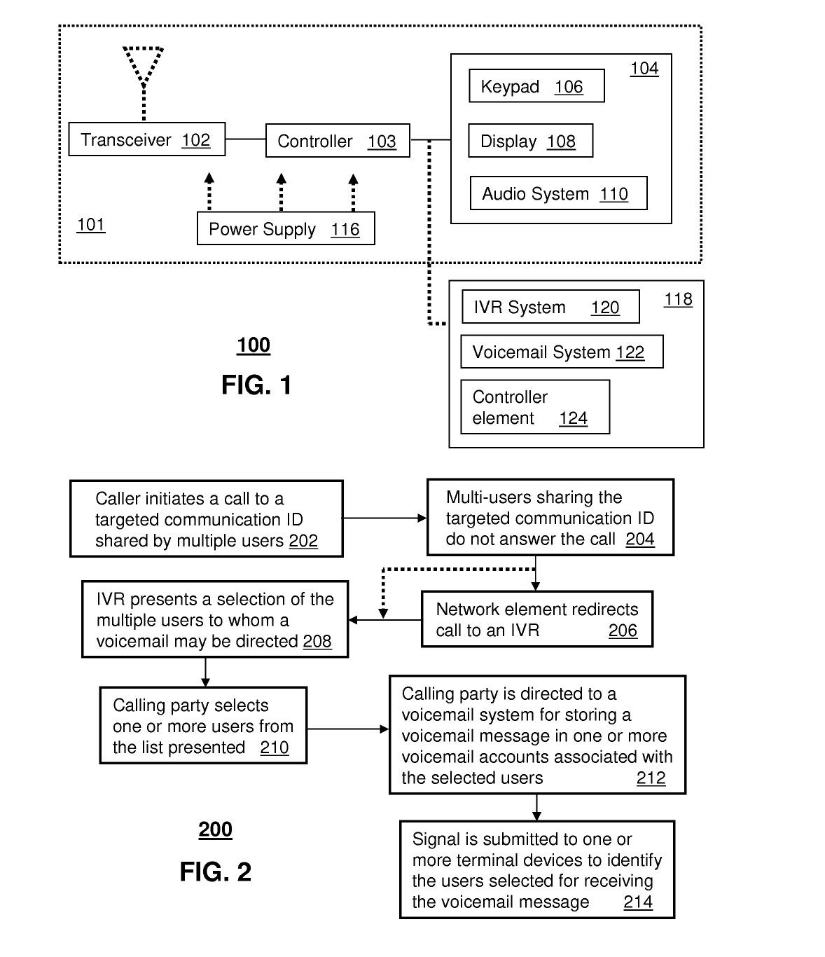

FIG. 1 depicts an exemplary embodiment of a communication system 100. The communication system 100 can comprise a terminal device 101 and a call processing system (CPS) 118. The terminal device 101 can comprise a wireless or wireline transceiver 102, a user interface (UI) 104, a power supply 116, and a controller 103 for managing operations of the foregoing components. The transceiver 102 can utilize common communication technologies to support singly or in combination any number of wireline access technologies such as cable, xDSL, Public Switched Telephone Network (PSTN), and so on.

Singly or in combination with the wireline technology, the transceiver 102 can support singly or in combination any number of wireless access technologies including without limitation Digital Enhanced Cordless Telecommunications (Dect), Bluetooth™, Wireless Fidelity (WiFi), Worldwide Interoperability for Microwave Access (WiMAX), Ultra Wide Band (UWB), software defined radio (SDR), and cellular access technologies such as CDMA-1X, W-CDMA/HSDPA, GSM/GPRS, TDMA/EDGE, and EVDO. SDR can be utilized for accessing public and private communication spectrum with any number of communication protocols that can be dynamically downloaded over-the-air to the terminal device 101. It should be noted also that next generation wireline and wireless access technologies can also be applied to the present disclosure.

The UI element 104 can include a keypad 106 with depressible or touch sensitive keys and a navigation element such as a navigation disk, button, roller ball, or flywheel for manipulating operations of the terminal device 101. The keypad 106 and its components can be illuminated by light sources such as light emitting diodes (LEDs) that can be adjusted to generate controlled light emissions of various colors. The UI element 104 can further include a display 108 such as monochrome or color LCD (Liquid Crystal Display) which can be touch sensitive for manipulating operations and for conveying images to the end user of the terminal device 101, and an audio system 110 that utilizes common audio technology for conveying and intercepting audible signals of the end user.

The power supply 116 can utilize common power management technologies such as replaceable batteries, supply regulation technologies, and charging system technologies for supplying energy to the components of the terminal device 101 and to facilitate portable applications. Depending on the type of power supply 116 used, the terminal device 101 can represent an immobile or portable communication device. The controller 103 can utilize computing technologies such as a microprocessor and/or digital signal processor (DSP) with associated storage memory such a Flash, ROM, RAM, SRAM, DRAM or other like technologies for controlling operations of the terminal device 101.

The terminal device 101 can represent a single operational device or a family of devices configured in a master-slave arrangement. In the latter embodiment, the components of the terminal device 101 can be reused in different form factors for the master and slave terminal devices.

The CPS 118 comprises an Interactive Voice Response (IVR) system 120, a voicemail system 122, and a controller element 124 for controlling operations of the IVR and voicemail systems. The IVR system 120 comprises common technology for presenting human and/or synthesized voice announcements to a calling party according to a calling tree managed by the controller element 124. The voicemail system 122 comprises common technology for storing voicemail messages delivered by calling parties. The voicemail messages can be stored in one or more voicemail accounts each assigned to a user of the communication system 100.

Although the IVR and voicemail systems 120, 122 are shown as an integral part of the CPS 118, said systems can alternatively operate as independent remote systems accessed by the CPS 118. In yet another embodiment, the CPS 118 and its components in whole or in part can be an integral part of the terminal device 101. From these embodiments, and the disclosure presented herein, it would be evident to an artisan with ordinary skill in the art that any of the components of the communication system 100 can be in whole or in part centralized or decentralized as desired.

FIG. 2 depicts an exemplary embodiment of a method 200 operating in the terminal device 101. Method 200 begins with step 202 in which a caller initiates a call to a targeted communication identifier shared by multiple users. The targeted communication identifier or ID can represent a Public Switched PSTN phone number commonly used in a circuit-switched communication system, or Session Initiation Protocol (SIP) or tElephone NUmber Mapping (ENUM) identifier utilized in packet-switched communication systems. ENUM is a Domain Name System (DNS)-based protocol. It provides a user with a domain name on an E.164 server in order to associate a telephone number with a Uniform Resource Identifier (URI) and other DNS-related services.

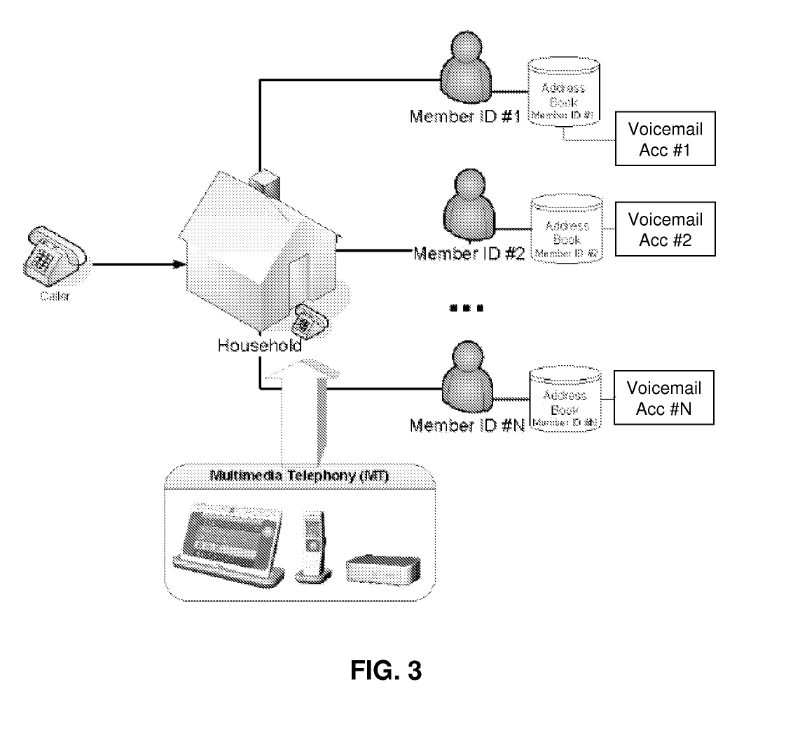

FIG. 3 depicts a multi-user setting for sharing one or more terminal devices 101. The plurality of users can share one terminal device 101, or each can have a terminal device 101 which operates from the same communication ID. In step 204, the CPS 118 detects that the call initiated by the caller has exceeded a number of rings indicating that the users of the targeted communication ID are not intending to answer the call. A network element associated with the CPS 118 such as a central office switch, or in an IP environment, an IP Multimedia Subsystem (IMS), redirects the call to the IVR system 120 upon detecting the excess rings.

Upon receiving the redirected call, the IVR system 120 presents the calling party a list of the multiple users associated with the targeted communication ID. The IVR system 120 instructs the calling party with human and/or synthesized voice announcements to select one or more users to whom a voicemail message can be directed. In step 210, the calling party responds with a selection of one or more users. The response can be produced by a voice and/or Dual Tone Multi-Frequency (DTMF) signals corresponding to one or more key depressions initiated by the calling party to indicate the one or more users selected. The response can also be demarcated by a voice and/or DTMF signal (e.g., “Done” or “#” sign) to indicate the completion of said selection.

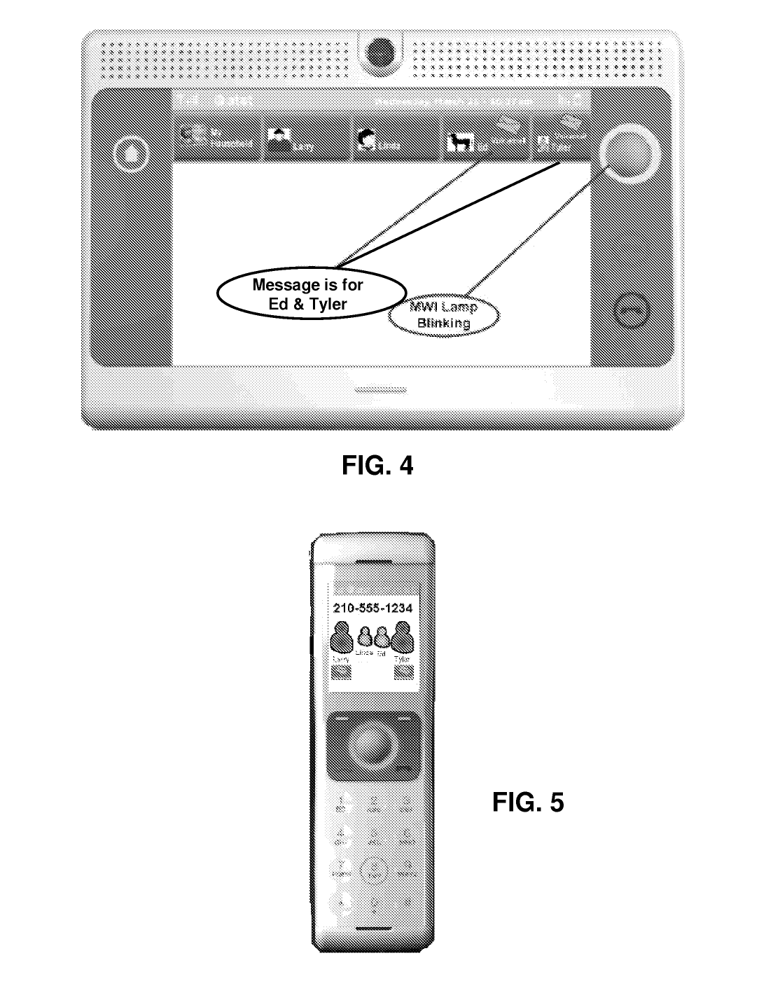

In step 212, the call is redirected to the voicemail system 122 in which the calling party is directed to record a voicemail message which is then stored in one or more voicemail accounts associated with the selected users. To assist the users of a multi-user household or commercial enterprise, the CPS 118 transmits one or more signals to at least one of the one or more terminal devices 101associated with the targeted communication ID for identifying the one or more users selected to receive the voicemail message. FIGS. 4-5 demonstrate the notification process of step 214 with a terminal device 101 having a form factor of a frame or base unit, and a terminal device having form factor of a handset.

The frame of FIG. 4 depicts four users in a dwelling or enterprise: Larry, Linda, Ed and Tyler. In this illustration, the calling party has chosen by way of the IVR system 120 to leave Ed and Tyler the same voicemail message. The one or more signals transmitted can represent signaling information such as Signaling System 7 (SS7) or IP signaling information such as Session Initiation Protocol (SIP) or H.323 signaling information to inform the one or more terminal devices 101 who the voicemail is directed to and to assert one or more message waiting indicators (MWI) as shown in FIG. 4. The indication as to who has a pending voicemail can be enhanced by enlarging a person's icon as shown in the display 108 of the frame and handset of FIGS. 4-5, respectively.

Upon reviewing the aforementioned embodiments, it would be evident to an artisan with ordinary skill in the art that said embodiments can be modified, reduced, or enhanced without departing from the scope and spirit of the claims described below. For example, as noted earlier, the components of the communication system 100 depicted in FIG. 1 can be in whole or in part centralized or decentralized. Method 200 has been described in an embodiment in which the terminal devices 101 and the CPS 118 are remote systems operating independently from each other. In an alternative embodiment, the CPS 118 can be an integral part of one of the terminal devices 101 (for example, the frame of FIG. 4). In this embodiment, step 206 can be removed. That is, when a call from the calling party is unanswered after a predetermined number of rings (e.g., not to exceed 6 rings), the terminal device 101 accepts the call and engages the integrated IVR system 120 to present the announcements previously described. The calling party then has the option to select one or more users in the household or enterprise by way of a voice and/or DTMF response. The IVR system 120 then directs the call to the voicemail system 122 integral to the frame that records and stores the voicemail message of the calling party in one or more accounts selected by the calling party.

In a master-slave setting in which the terminal device 101 comprises a master terminal device (e.g., the frame of FIG. 4) and multiple slave terminal devices directed thereby, the master terminal device signals the one or more slave terminals of the selected parties to indicate a pending voicemail message. In this embodiment the slave terminal devices can show that the voicemail message is directed to other parties as well, or can just show a voicemail message notice to the user assigned to the slave terminal device.

These are but a few examples of modifications that can be applied to the present disclosure without departing from the scope of the claims stated below. Accordingly, the reader is directed to the claims section for a fuller understanding of the breadth and scope of the present disclosure.

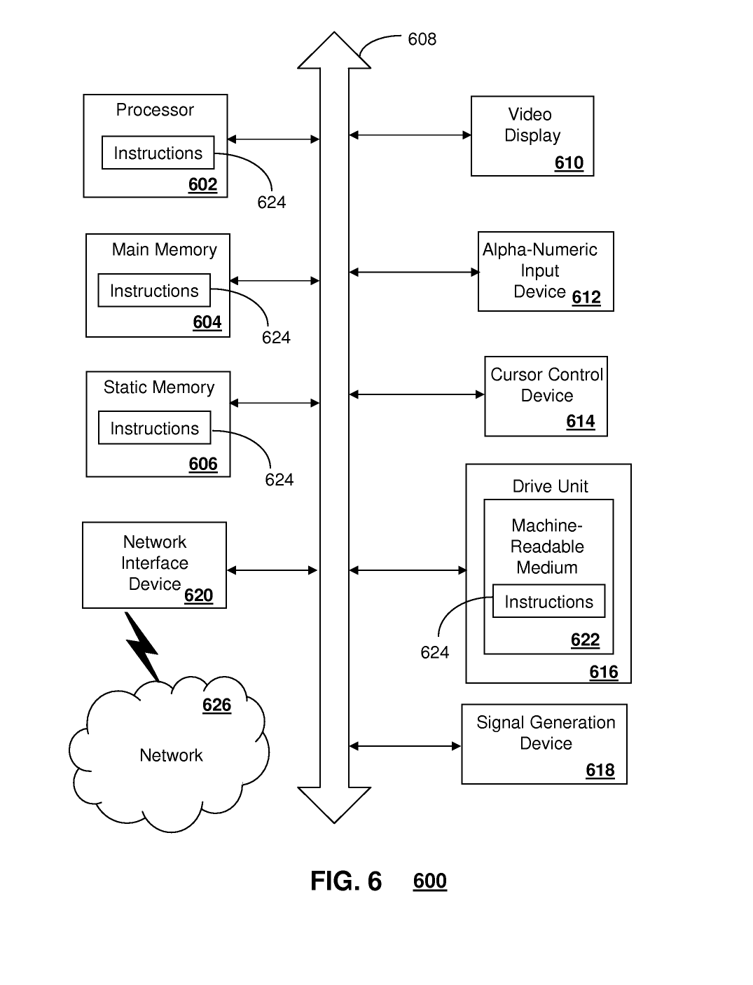

FIG. 6 depicts an exemplary diagrammatic representation of a machine in the form of a computer system 600 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 may include a processor 602 (e.g., a central processing unit (CPU), a graphics processing unit (GPU, or both), a main memory 604 and a static memory 606, which communicate with each other via a bus 608. The computer system 600 may further include a video display unit 610 (e.g., a liquid crystal display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control) and a network interface device 620.

The disk drive unit 616 may include a machine-readable medium 622 on which is stored one or more sets of instructions (e.g., software 624) embodying any one or more of the methodologies or functions described herein, including those methods illustrated above. The instructions 624 may also reside, completely or at least partially, within the main memory 604, the static memory 606, and/or within the processor 602 during execution thereof by the computer system 600. The main memory 604 and the processor 602 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A Call Processing System (CPS), comprising a controller element that receives a redirected call initiated by a calling party attempting to communicate with at least one among a plurality of users sharing one or more terminal devices associated with a targeted communication identifier, presents the calling party an option to select one or more users among the plurality of users, and directs the calling party to a voicemail system for storing a voicemail message in one or more voicemail accounts associated with the one or more users selected.

2. The CPS of claim 1, wherein the CPS comprises an Interactive Voice Response (IVR) system, and wherein the controller element presents the calling party one among one or more pre-recorded human voice announcements and one or more synthesized voice announcements according to a calling tree that describes the option to select one or more of the plurality of users.

3. The CPS of claim 1, wherein the controller element receives and processes a voice response from the calling party indicating the one or more users selected.

4. The CPS of claim 1, wherein the controller element receives and processes one or more Dual Tone Multi-Frequency (DTMF) signals corresponding to one or more key depressions initiated by the calling party to indicate the one or more users selected.

5. The CPS of claim 1, wherein the controller element detects the selection of the one or more users followed by a demarcation to denote a completion of said selection.

6. The CPS of claim 5, wherein the demarcation comprises one among a DTMF signal and a voice signal.

7. The CPS of claim 1, wherein the controller element transmits one or more signals to at least one of the one or more terminal devices associated with the targeted communication identifier for identifying the one or more users selected to receive the voicemail message.

8. The CPS of claim 1, wherein the voicemail system is an integral part of the CPS.

9. The CPS of claim 1, wherein the voicemail system is an integral part of a select one of the one or more terminal devices.

10. The CPS of claim 1, wherein the CPS is an integral part of a select one of the one or more terminal devices.

11. The CPS of claim 1, wherein the controller element receives the redirected call in response to a network element of a communication system from which the one or more terminal devices operate detecting an unanswered call at the targeted communication identifier.

12. The CPS of claim 1, wherein the targeted communication identifier is associated with one among a packet-switched and circuit-switched communication service.

13. A voicemail system, comprising a controller element that stores a voicemail message of a calling party in one or more voicemail accounts associated with one or more users sharing a targeted communication identifier, wherein the one or more voicemail accounts are selected by the calling party by way of an Interactive Voice Response (IVR) system.

14. The voicemail system of claim 13, wherein the IVR system is an integral part of the voicemail system, and wherein the controller element presents to the calling party one among one or more pre-recorded human voice announcements and one or more synthesized voice announcements according to a calling tree that describes the option to select one or more of the plurality of users.

15. The voicemail system of claim 13, wherein the controller element receives and processes a voice response from the calling party indicating the one or more users selected.

16. The voicemail system of claim 13, wherein the controller element receives and processes one or more Dual Tone Multi-Frequency (DTMF) signals corresponding to one or more key depressions initiated by the calling party to indicate the one or more users selected.

17. The voicemail system of claim 13, wherein the controller element detects the selection of the one or more users followed by a demarcation to denote a completion of said selection, and wherein the demarcation comprises one among a DTMF signal and a voice signal.

18. The voicemail system of claim 13, wherein the controller element transmits a signal to at least one among one or more terminal devices associated with the targeted communication identifier for identifying the one or more users selected to receive the voicemail message.

19. The voicemail system of claim 13, wherein the controller element receives a redirected call in response to a network element detecting an unanswered call at the targeted communication identifier, and wherein the IVR presents the calling party the announcements according to the calling tree.

20. A computer-readable storage medium in a terminal device, comprising computer instructions for receiving a notice identifying a user among a plurality of users sharing a targeted communication identifier from which the terminal device operates, the notice identifying a pending voicemail message originating from a calling party that directs by way of an Interactive Voice Response (IVR) system the voicemail message to the user identified by the notice.
